(19) United States
(12) Patent Application Publication
(10) Pub. No.: US 2004/0144702 A1
(43) Pub. Date: Jul. 29, 2004

(54) Controller for salt dosage for a water softener and method of regenerating a water softener

(75) Inventors: Jeffrey A. Zimmerman, Forest Lake, MN (US); Ralph H. Larson, Bayport, MN (US); Paul C. Myhre, Woodbury, MN (US)

Correspondence Address: Thomas W. Ryan, PIPER RUDNICK LLP, P.O. Box 64807, Chicago, IL, 60664-0807, US

(73) Assignee: ECOWATER SYSTEMS, INC.

(21) Appl. No.: 10/757,647

(22) Filed: Jan. 13, 2004

Related U.S. Application Data
(62) Division of application No. 09/758,830, filed on Jan. 11, 2001, now abandoned.
Application No. 09/758,830 is a continuation-in-part of application No. 09/016,203, filed on Jan. 30, 1998, now Pat. No. 6,284,132.

(51) Int. Cl. C02F 5/00

(52) U.S. Cl. 210/149; 210/190

(57) ABSTRACT

A water softener and a method of operating the same are provided to allow for the efficient use of either NaCl or KCl as the regenerant salt. A user interface is provided to allow the user to indicate to the computer controlling the water softener whether NaCl or KCl is being used. The computer controller adjusts the fill time and brine time, depending on the type of regenerant salt used and on the temperature of the brine.

This application is a continuation in part of U.S. application Ser. No. 09/016,203, filed Jan. 30, 1998.

### BACKGROUND OF THE INVENTION

1. Field of the Invention

The present invention relates to the art of water softening systems. More particularly, the present invention is directed to a method and apparatus for the efficient use of potassium chloride as the regenerant in a water softener.

2. Description of Related Art

A number of different methods and systems are known in the art for softening water. The water softening process involves the replacement of “hard” ions, such as calcium and magnesium, with “soft” ions such as sodium and potassium. Soft water is often desirable because it is less likely to leave deposits on plumbing fixtures.

Water softeners typically utilize an ion exchange material, typically present as a resin bed, to soften water. In the water softening process untreated water is brought into contact with the resin bed where “hard” ions are exchanged for “soft” ions to provide a source of softened water. After prolonged contact with untreated water, however, the capacity of the resin bed to soften water becomes exhausted. When this occurs, the resin bed may be regenerated by exposing it to a brine solution containing the desired “soft” ions, which process restores its water softening capacity.

The brine needed for regeneration may be formed by dissolving in a quantity of water a regenerant salt having the desired “soft” ions. Typical regenerant salts are sodium chloride and potassium chloride. The type of regenerant salt used determines what type of “soft” ions will be present in the softened water. In particular, sodium chloride results in sodium ions being introduced into the softened water, and potassium chloride results in potassium ions being introduced into the softened water.

Many water softeners regenerate the resin bed automatically. In such systems the resin bed is in service most of the time softening water. When the water softener system determines that regeneration is required, it stops softening water and instead regenerates the resin by exposing it to the brine. A number of different methods are known for automatically determining when to initiate a regeneration. Some of these methods are described in U.S. Pat. Nos. 5,544,072 and 4,722,797, which are incorporated herein by reference. Typically, in such methods, regenerations are performed before the resin bed is completely exhausted, in order to ensure that the user does not run out of soft water.

In addition to determining when to regenerate, many systems automatically select the amount of regenerant to be used in a regeneration step. The regenerant is often provided in the form of dry regenerant salt located in a vessel separate from the resin bed, termed the “brine tank.” A measured amount of water is introduced into the brine tank in order to dissolve the desired amount of regenerant, forming a brine. Typically, the rate at which water enters the brine tank, the “fill rate,” is fixed, so that the fill time determines the amount of water introduced and therefore the amount of regenerant salt dissolved. The brine is then transferred from the brine tank to the resin bed, so that the resin bed is exposed to a known amount of regenerant during the regeneration process. The used brine is then disposed of as waste.

Sodium chloride (NaCl) has been the regenerant salt most commonly used in water softeners. However, the use of potassium chloride (KCl) as the regenerant is an attractive alternative. The potassium ions added to soft water from softeners regenerated with KCl are more beneficial to human health as well as to plant life than the sodium ions added to soft water from softeners regenerated with NaCl. The use of KCl as the regenerant also often results in less chloride being present in the waste brine, making its disposal less environmentally damaging.

Most water softeners, however, are designed for NaCl regenerant and lack the flexibility to operate adequately if KCl is used as the regenerant instead. In particular, if KCl is used as the regenerant, the resin bed may become exhausted prematurely, i.e., before it is regenerated. As a result, the user would run out of soft water. The problem becomes more acute as a function of water temperature and softener efficiency, i.e., the colder the water is that is used to form the brine and the more efficiently the water softener uses regenerant salt, the more likely premature exhaustion is.

Moreover, the use of KCl as the regenerant is more complicated than the use of NaCl for a number of reasons. First, in certain operational regimes, namely, when the resin bed is used most efficiently, the resin bed requires a greater amount of KCl than NaCl for regeneration. Second, the solubility of KCl in water is highly temperature dependent, unlike NaCl. In particular, the solubility of KCl in cold water is greatly reduced relative to NaCl. As a result, when cold water is used to form the brine, a greater amount of water is required to dissolve the KCl. Third, the dissolution of KCl in water is significantly endothermic, so that the KCl cools the water as it dissolves, thereby lowering its solubility even more. Finally, KCl dissolves in water at a slower rate than NaCl.

U.S. Pat. Nos. 5,544,072 and 4,722,797 each disclose a method and apparatus for operating a water softener. These references also disclose that either potassium chloride or sodium chloride may be used as the regenerant, but they do not suggest any changes to the water softening method or apparatus depending on whether NaCl or KCl is used. Such changes are required, however, because of the different characteristics of these two salt types. As a practical matter, then, water softeners in accordance with these references do not have the flexibility to be able to use either NaCl or KCl at the option of the user. Moreover, these references do not disclose any way of accounting for the more complicated characteristics of KCl, such as its temperature dependent solubility, in order to use KCl as a regenerant in an efficient and reliable manner.

### SUMMARY OF THE INVENTION

The principal object of the present invention is to provide a water softener and a method of operating the same to allow for the efficient and reliable use of KCl as the regenerant salt.

Another object of the present invention is to provide a water softener method and apparatus having the flexibility to allow either NaCl or KCl to be used as the regenerant salt at option of the user.

Yet another object of the present invention is to provide a method and apparatus for filling the brine tank of a water softener to account for changes in the brine temperature occurring during the course of the fill and thereby to ensure that the required amount of regenerant salt is dissolved.

In accordance with the present invention, a water softener and a method of operating the same are provided to allow for the efficient and reliable use of either NaCl or KCl as the regenerant salt. A user interface is provided to allow the user to indicate to the computer controlling the water softener whether NaCl or KCl is being used. The computer controller adjusts the fill time and brine time depending on the type of regenerant salt used. The temperature of the brine is measured at regular intervals as water is being supplied to the brine tank to dissolve the KCl. At each interval the computer calculates the amount of water needed to dissolve the required amount of KCl, and the fill ends when the amount of water added is approximately equal to the required amount calculated at the most recent time interval.

### BRIEF DESCRIPTION OF THE DRAWINGS

FIG. 1 is a graph which illustrates curves representing the capacity of a typical resin bed as a function of the salt dosage used to regenerate it. The solid line corresponds to the use of NaCl as the regenerant, and the dotted line corresponds to the use of KCl.

FIG. 2 is a schematic representation of an automatic water softener in accordance with the present invention.

FIG. 3 is a schematic representation of a user interface for the water softener in accordance with the present invention.

FIG. 4 is a graph showing the relationship between brine temperature and the water volume equivalency of KCl with respect to NaCl.

FIG. 5 is a graph showing the relationship between brine temperature and the water volume adjustment rate to obtain equivalent amounts of KCl in solution.

### DESCRIPTION OF THE PREFERRED EMBODIMENT

Water hardness is typically expressed in terms of grains per gallon, which represents the weight in grains of calcium carbonate (CaCO₃) which would be needed to be dissolved in one gallon of water to achieve that level of hardness. The capacity of a resin bed, which represents the amount of water of a given hardness it can soften before becoming exhausted, is therefore expressed in grains as follows:

C=H×V

where C=capacity of the resin bed in grains, H=the hardness of the water in grains per gallon, and V=the amount of water in gallons at that hardness that can be treated by the resin bed before exhausting it.

When the resin bed becomes exhausted, it may be regenerated by exposing it to a brine comprising a quantity of regenerant salt dissolved in water. The salt dosage, dissolved in water as a brine, required to regain the desired capacity depends on the efficiency of the resin bed. The efficiency, E, of a resin bed is defined as follows:

E=C/D

where D=the dosage of regenerant salt applied to the resin bed in pounds, and C=the capacity of the resin in grains resulting from that salt dosage.

The water softening process, to the extent that it involves the removal of calcium ions, involves the exchange of either two Na⁺ ions or two K⁺ ions for one Ca²⁺ ion. Since the molecular weights of CaCO₃, KCl, and NaCl are 100.09, 74.56, and 58.44, respectively, and since 1 pound=7000 grains, the theoretical efficiency is 5995 grains/lb. when NaCl is used and 4699 grains/lb. when KCl is used. Theory thus predicts that NaCl is 28% more efficient as a regenerant salt than KCl, with the result that more KCl would be required for regeneration in order to achieve the same capacity.

In practice, however, resin beds approach their theoretical efficiencies only when low salt dosages are used. The reason for this is that the capacity cannot be increased without limit by increasing the salt dosage. With higher salt dosages, the resulting capacity levels off and gradually approaches a limiting value. Put another way, as the salt dosage is increased, the efficiency falls increasingly below its theoretical value. Moreover, it has been found that for sufficiently high salt dosages, the amount of NaCl and KCl needed to achieve the same capacity becomes essentially the same.

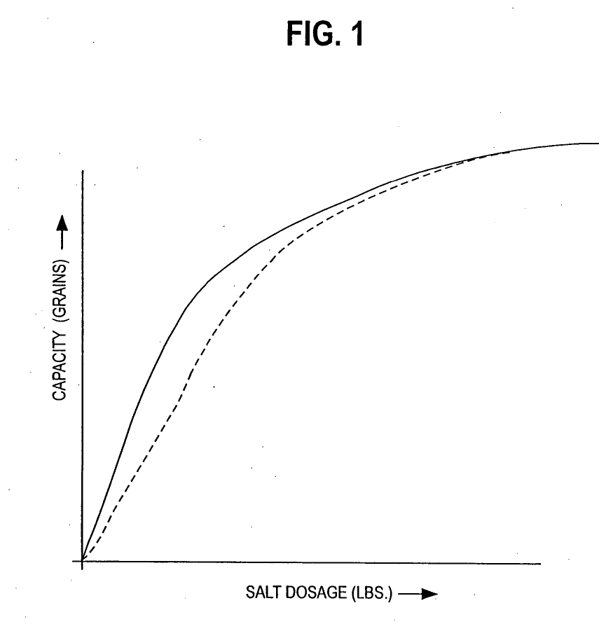

This general trend is illustrated schematically in FIG. 1, which is a graph of the capacity of a typical resin bed in grains as a function of NaCl and KCl dosage in pounds. The NaCl curve is a solid line, and the KCl curve is a dotted line. As shown in that graph, when low salt dosages are used, NaCl results in a greater capacity than the same dosage of KCl. However, with higher salt dosages the resulting capacity becomes nearly independent of the type of salt used.

Many water softeners operate in the regime where NaCl and KCl have nearly the same efficiency. However, a more efficient use of regenerant salt is obtained by using lower salt dosages, albeit at the cost of more frequent regeneration. In this regime, then, the lower efficiency of KCl, as compared to NaCl, must be compensated for by increasing the KCl dosage during regeneration.

Preferably, curves for KCl and NaCl like those in FIG. 1 are generated for each resin bed to determine the salt dosage required to achieve the desired capacities. Such data is typically obtained by exhausting the resin bed until the effluent water has a hardness of one grain per gallon. The resin bed is then regenerated with a regenerant brine having a selected salt dosage. Water of a known hardness is passed through the resin bed until the effluent water reaches a hardness of one grain per gallon. The amount of water that has passed through the resin bed is measured, and from this quantity the capacity of the resin bed may be calculated. This procedure is then repeated for various salt dosages to generate the curve of capacity versus salt dosage as in FIG. 1.

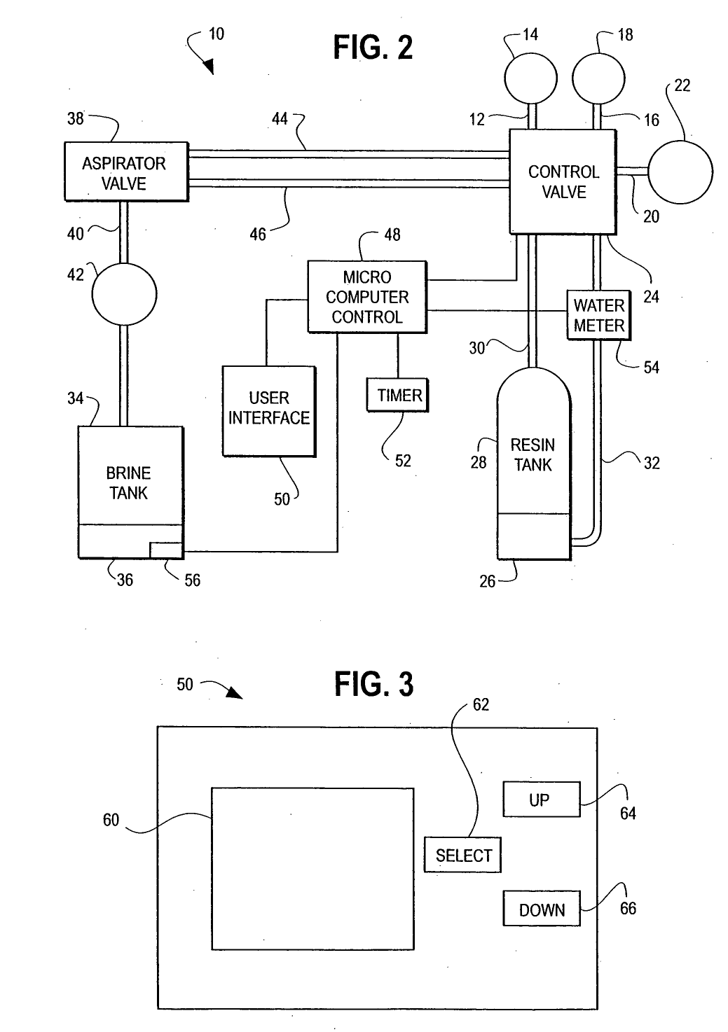

An automatic water softener 10 adapted to use potassium chloride in accordance with the present invention is shown schematically in FIG. 2. When water softener 10 is “in service” it is designed to treat hard water to provide a source of soft water. Periodically, water softener 10 automatically goes out of service, thereby ceasing the softening of water, and enters a “regeneration cycle” designed to regenerate its capability to soften water.

With reference to FIG. 2, water softener 10 preferably includes a source pipe 12, connected to a source of hard water 14, a destination pipe 16, connected to a destination 18 intended to use the softened water, and a drain pipe 20 connected to a drain 22. Pipes 12, 16, and 20 are also connected to a control valve 24. A resin bed 26, preferably comprising particles of ion exchange resin, is disposed in a resin tank 28. A pipe 30 and a pipe 32 connect resin tank 28 to control valve 24. A brine tank 34 holds a quantity of a regenerant salt 36, typically NaCl or KCl, and is connected to an aspirator valve 38 by a pipe 40. Pipe 40 includes a brine valve 42. Pipes 44 and 46 connect aspirator valve 38 to control valve 24. Control valve 24 may be configured to interconnect pipes 12, 16, 20, 30, 32, 44, and 46 in a number of different ways hereinafter described.

Water softener 10 preferably includes a micro computer controller 48 having a user interface 50. User interface 50, shown schematically in FIG. 3, preferably includes an LCD display 60, and various buttons, such as a “SELECT” button 62, an “UP” button 64, and a “DOWN” button 66, to allow the user to selectively view and enter in information. A timer 52 is provided to enable controller 48 to measure time durations. A water meter 54 is placed in either pipe 30 or pipe 32 to enable controller 48 to measure the amount of water flowing through resin tank 28. A temperature sensor 56 is preferably disposed in brine tank 34 to enable controller 48 to measure the temperature therein. Temperature sensor 56 is preferably a thermocouple or a semiconductor device. Controller 48 sets the configuration of control valve 24.

When in service, hard water from source 14 passes through supply pipe 12 to control valve 24, which is configured so that the hard water then flows through pipe 30 to resin tank 28. In resin tank 28 the hard water passes through resin bed 26, where it is softened by an ion exchange process. The soft water flows out from resin tank 28 through pipe 32 to control valve 24. Control valve 24 is configured to direct the soft water from pipe 32 to pipe 16, where it is directed to its destination 18.

When the resin bed 26 loses its capacity to effectively soften the water passing through it, regeneration is necessary. The regeneration cycle preferably includes the following steps: (1) fill; (2) brine draw; (3) slow rinse; (4) backwash; and (5) fast rinse. During the fill step, a quantity of water flows into brine tank 34 to dissolve a quantity of the salt 36 therein in order to make the amount of brine necessary for regeneration. Specifically, control valve 24 is configured so that hard water from source 14 flows through pipe 12 to pipe 30 to resin tank 28. The hard water passes through resin bed 26 and flows out through pipe 32 to control valve 24. Control valve 24 is configured to direct this water to pipe 44 and then to pipe 40 through aspirator valve 38. Brine valve 42 opens in response to the flow of water in pipe 40, allowing the water to enter brine tank 34. The water filling brine tank 34 dissolves a quantity of the salt 36 to form a brine, whereby the brine is substantially saturated. Temperature sensor 56 preferably measures the temperatures of the water and of the resulting brine. The duration of the fill step determines the amount of water that enters brine tank 34 and therefore the amount of regenerant salt dissolved and available for regeneration.

During the brine draw step, control valve 24 is configured so that hard water from pipe 12 is directed to pipe 44, whereupon it flows through aspirator valve 38 to pipe 46. This flow through aspirator valve 38 creates suction on pipe 40 by the Venturi effect. Brine valve 42 is open, so that the suction on pipe 40 draws the brine in brine tank 34 formed during the fill step, up into pipe 40, which then flows through aspirator valve 38 to pipe 46. Control valve 24 is configured so that the water and brine from pipe 46 are directed through pipe 30 to resin tank 28. The brine entering resin tank 28 flows through resin bed 26, thereby regenerating it, and flows out through pipe 32 as waste. The waste is directed to drain 22 via pipe 20 for its disposal. The duration of the brine draw step is sufficiently long so as to withdraw all or nearly all of the brine from brine tank 34. Preferably, brine valve 42 closes automatically when the level of brine in brine tank 34 falls below a prescribed point.

During the slow rinse step, brine valve 42 is closed, and brine is no longer withdrawn from brine tank 34. However, water keeps flowing as in the brine draw step. In particular, the configuration of control valve 24 is the same as for the brine draw step. The remaining brine continues to flow through resin bed 26 until replaced with incoming water in order to achieve maximum ion exchange and to continue to flush out any hardness minerals or brine which may remain in resin tank 28.

During the backwash and fast rinse steps, control valve 24 is configured so that hard water from pipe 12 is directed to pipe 30 and flows into resin tank 28. The water flows out of resin tank 28 through pipe 32 and is directed to drain 22 via pipe 20. During the backwash step, the water flows up through resin bed 26, lifting up and expanding the resin bed 26 and flushing out iron minerals, dirt, sediments, hardness minerals, and any remaining brine. During the fast rinse step, a fast flow of water is directed downward through resin bed 26 to pack it and prepare it for service.

Controller 48 determines when to regenerate resin bed 26 and to what capacity. Various methods may be used for these determinations, such as those described in U.S. Pat. Nos. 5,544,072 and 4,722,797. The necessary capacity will, in general, depend on the hardness of the water to be treated. User interface 50 therefore preferably includes means by which the user can enter the water hardness, expressed in grains per gallon, into controller 48. To accommodate the use of different types of regenerant salt, user interface 50 also enables the user to specify the type of salt used, e.g., whether NaCl or KCl is used.

Preferably, the user-adjustable parameters, which typically include the time of day for regeneration, the water hardness, and the type of regenerant salt used, are shown as various “screens” on display 60, with each parameter having its own screen. At each screen, the user is able to scroll up and down through the available values for the parameter by pressing “UP” button 64 and “DOWN” button 66, respectively. The user indicates the desired value for the parameter by pressing “SELECT” button 62, whereupon the value is stored by computer controller 48 and the next “screen” is shown on display 60. In this way, the user is able to scroll through the available salt types, such as NaCl and KCl, and to make a selection. Other means for indicating the regenerant salt type, such as other types of computer interfaces or mechanical switches, could also be used.

From the desired capacity to which resin bed 26 is to be regenerated, the required salt dose may be determined from empirical data as described above. The salt dosages, D, for each desired regenerated capacity, C, are programmed into controller 48 for the various salt types intended to be used, such as NaCl and KCl. Thus, from the type of salt used and the regenerated capacity required, controller 48 is able to determine the salt dosage, D, needed for regeneration.

The value of D, the salt dosage, determines the amount of water that must be supplied to brine tank 34 during the fill step, based on the solubility of that salt. Preferably, the amount of water added during the fill step is determined by the fill time, the flow rate being a fixed quantity. The required fill time may thus be calculated as follows:

F=D/(R×S)

where F=fill time in minutes, D=the salt dosage in pounds, R=the fill rate in gallons per minute, and S=the solubility of the salt in pounds per gallon. When KCl is used as the regenerant salt, however, an added complication arises in that its solubility is markedly temperature dependent over the typical range of water temperatures encountered, namely, 34° F. to 80° F., whereas the solubility of NaCl is relatively constant over this range. In particular, the solubilities of NaCl and KCl are both approximately 2.99 lbs./gal. at 80° F. At lower temperatures, the solubility of KCl is significantly less than that of NaCl as summarized in Table 1. The information in Table 1 has been generated from empirical data linearized in the range of 34° F. to 80° F., with the solubility of NaCl taken to be a constant 2.99 lbs./gal. The data of Table 1 is representative only, in that results can be affected by the water chemistry in the particular application.

TABLE 1

| Temp. | KCl Solubility | KCl/NaCl |
|---|---|---|
| (° F.) | (lbs./gal.) | Difference (%) |
| 34 | 2.35 | 27.2% |
| 36 | 2.38 | 25.7% |
| 38 | 2.40 | 24.2% |
| 40 | 2.43 | 22.8% |
| 42 | 2.46 | 21.4% |
| 44 | 2.49 | 20.1% |
| 46 | 2.51 | 18.8% |
| 48 | 2.54 | 17.5% |
| 50 | 2.57 | 16.2% |
| 52 | 2.60 | 14.9% |
| 54 | 2.63 | 13.7% |
| 56 | 2.65 | 12.5% |
| 58 | 2.68 | 11.4% |
| 60 | 2.71 | 10.2% |
| 62 | 2.74 | 9.1% |
| 64 | 2.76 | 8.0% |
| 66 | 2.79 | 6.9% |
| 68 | 2.82 | 5.9% |
| 70 | 2.85 | 4.9% |
| 72 | 2.88 | 3.8% |
| 74 | 2.90 | 2.8% |
| 76 | 2.93 | 1.9% |
| 78 | 2.96 | 0.9% |
| 80 | 2.99 | 0.0% |

To accommodate the use of KCl, the fill times should be adjusted on the basis of water temperature to reflect the temperature dependent solubility of KCl. The simplest approach to account for this effect is not to measure the actual water temperature at all but to simply assume a typical water temperature and to increase accordingly the fill time for KCl by a fixed percentage relative to the fill time that would be required if NaCl were used. An increase in the fill time of 25% is found to be a reasonably adequate approximation for the most typical water temperatures encountered.

A more accurate system includes temperature sensor 56 in order to enable controller 48 to determine the temperature of the water being supplied to brine tank 34. Temperature sensor 56 is preferably located in brine tank 34 but may alternatively be located upstream, such as in source pipe 14. Controller 48 is programmed with the solubilities of KCl at various water temperatures, so that when KCl is used as the regenerant salt controller 48 measures the water temperature and sets the required fill time accordingly.

Alternatively, the water temperature may be a user-adjustable parameter entered into computer controller 48 by means of user interface 50 as previously described.

The temperature of the brine formed in brine tank 34 does not remain constant during the course of the fill. An example of how the brine temperature changes during the course of a fill when KCl is used as the regenerant salt is shown in tabular form in Table 2. This temperature changed is caused by two factors. First, before the fill begins, the temperatures of the water and of brine tank 34 with dry regenerant salt 36 present within will not in general be equal, so that the brine temperature will naturally equilibrate during the course of the fill. Second, the dissolution process of the salt also changes the temperature of the brine. In particular, the dissolution of KCl is significantly endothermic, so that the dissolution process itself cools the brine.

The temperature change of the brine during the course of the fill thus presents an added difficulty in the case of KCl because of its temperature dependent solubility. Temperature sensor 56 should thus measure the temperature during the course of the fill, preferably at regular intervals such as every minute. Typical results under this method are tabulated in Table 2.

TABLE 2

| | | | Required | |
|---|---|---|---|---|
| | Sample | | Fill | Required |
| Fill Time | Temp | Solubility | Water | Fill Time |
| (Min) | (° F.) | (lbs/gal) | (gal) | (min) |
| 0 | 60 | 2.7048 | 2.219 | 7.40 |
| 1 | 56 | 2.6492 | 2.265 | 7.55 |
| 2 | 52 | 2.5937 | 2.3133 | 7.71 |
| 3 | 48 | 2.5381 | 2.3640 | 7.88 |
| 4 | 46 | 2.5103 | 2.3902 | 7.97 |
| 5 | 44 | 2.4826 | 2.4168 | 8.06 |
| 6 | 42 | 2.4548 | 2.4442 | 8.15 |
| 7 | 41 | 2.4409 | 2.4581 | 8.19 |
| 8 | 40 | 2.4270 | 2.4722 | 8.24 |
| 8.24 | — | END OF | FILL | — |

The adjustment in water volume to add to the brine tank to account for the difference in solubility of potassium chloride at different temperatures is as is found in Table 1. Based on Table 1, the average change in solubility (pounds of salt per gallon of water) of KCl is 0.014 pounds per gallon per “minus” degree Fahrenheit over the range of 80° F. to 34° F. Thus, the KCl solubility, in pounds per gallon, is related to the temperature of the brine solution as follows:

KCl solubility=2.99−(80−brine temperature)(0.014)

To determine the water volume equivalency (i.e., the gallons of water to add to obtain one pound of KCl in solution as compared to the amount of water to obtain one pound of NaCl in solution, at a temperature) the relationship is NaCl solubility÷KCl solubility at the temperature. Thus, the water volume equivalency of KCl is 1.27234 @ 34° F., 1.23045 @ 40° F., 1.16342 @ 50° F., 1.10332 at 60° F., 1.04912 @ 70° F., and 1.0000 at 80° F.

Based on the above, the water adjustment rate for temperature, sometimes referred to as WARFT, (additional percentage of water required for equivalent KCl in solution per degrees below 80° F.) is 0.592% more water per degree over the temperature range of 80° F. to 34° F.; calculated by change in water equivalency rate over the temperature range divided by the temperature difference, i.e., (1.27234−1.0000)+46. Additional adjustment rates over different temperature ranges, as determined from the data, are: 0.49% for the range 80° to 70°; 0.52% for the range 80° to 60°; 0.55% for the range 80° to 50°; and 0.58% for the range 80° to 40°. Each of these rates is the percent increase in water required, that is, in addition to the water determined for a brine solution at 80° F., for each ° F. the brine temperature is below 80° F. Thus, it is believed that good results can be obtained if the water volume is adjusted at a rate in the range of 0.49% to 0.59% per ° F. difference, and the preferred range is 0.55% to 0.58% per ° F. difference. Accordingly, if the temperature in the brine tank is 40° F., the amount of water to be added to the brine tank should be increased by about 23.2% (determined by adjustment rate of +0.58%/° F., times a temperature difference of 40°) in addition to the amount of water which would be added if the temperature were at 80° F.

Additionally, the data in Table 1 shows that the rate of water adjustment for temperature differences for potassium chloride is substantially linear in the range of temperatures ordinarily expected for the brine, and has been found to be directly related to the water temperature as follows: the rate equals [0.488+0.0029 (70−brine temperature)]÷100, which equals (6.91−0.029 brine temperature) 10⁻³. As an example, using this relationship to determine the water adjustment rate for brine solution at 60° F., the rate equals [0.488+0.0029 (70−60)]÷100, i.e., 0.00517 increase per degree of brine temperature difference from 80° F., and at 34° F. the rate is [0.488+0.0029 (70−34)]÷100=0.00592 increase in water per degree of brine temperature difference from 80° F. These rates can be used to determine a water adjustment adder, which is WARFT times (80−temperature of brine solution), and a water adjustment multiplier which is 1+water adjustment adder. Thus water adjustment rates and multipliers, based on the above relationships are as follows:

| Brine | Water Adjustment | Water Adjustment |
|---|---|---|
| Temperature | Rate | Multiplier |
| 34° | 0.00592 | 1.27232 |
| 40° | 0.00575 | 1.23000 |
| 50° | 0.00546 | 1.16380 |
| 60° | 0.00517 | 1.10340 |
| 70° | 0.00488 | 1.04880 |

Referring now to Table 2, the required fill time is directly related to the volume of water desired. In the example of Table 2, the fill rate is 0.3 gallons per minute. With a constant fill rate, the brine fill time determines the volume of water added to the brine tank, and the amount of the salt that can be in solution. The fill time can be adjusted according to the same water adjustment multiplier set forth above to obtain the desired quantity of water in the brine tank and a desired amount of KCL in solution, i.e., the brine, and which will be available to be delivered to the resin bed for regeneration. For example, if six pounds of KCL were to be delivered to the resin bed for regeneration, the volume of water to be delivered to the brine tank at 80° F. would be about 2.00 gallons and the brine fill time would be 6.666 minutes at a water delivery rate of 0.3 gallons per minute. If the brine temperature were 40° F., the water adjustment rate would be about 0.00575% increase per degree of temperature difference from 80° F., which temperature difference is 40°, thus, the water adjustment adder is 0.00232, i.e., 23.2% for a water adjustment multiplier of 1.23. Using that adjustment, the volume of water required @ 40° F. is about 2.46 gal. (2.000 @ 80°+2.000×0.23) and the brine fill time is about 8.2 minutes (6.666+6.666×0.23). Both of which compare favorably with 2.4722 gal. and 8.24 minutes as shown in Table 2.

The volume of water for the brine fill for KCL can be determined from the following relationships:

$$\begin{matrix}Water To Brine \\ Tank ( gallons )\end{matrix} = \frac{Salt}{Salt Solubility} ( 1 + WARFT \times dT )$$

Thus the gallons of water required at a brine temperature of BT is

$$\begin{matrix}Gallons of Water = \frac{Salt}{Salt solubility} ( 1 + \\ [ 0.488 + 0.0029 ( 70 - BT ) ] ( 80 - BT ) ) {10}^{- 2}\end{matrix}$$

which for potassium chloride equal salt (519.2−3.086BT+9.6(BT)²10⁻³)10⁻³ and

$$Brine Tank Fill Time ( minutes ) = \frac{Salt ( 1 + WARFT \times dT )}{Salt Solubility \times WDR}$$

which for potassium chloride equals:

$$= \frac{Salt}{WDR} ( 519.2 - 3.086 BT + 9.6 ( {( 40 )}^{2} {10}^{- 3} ) {10}^{- 3}$$

Wherein:

Salt=pounds of KCl salt desired for regeneration of resin bed.

Salt Solubility=solubility at 80° F., which is 2.99 lbs/gal for KCl

WARFT=water adjustment rate for temperature (increase per degree below 80°)

dT=temperature differential between brine temperature and 80° F.

WDR=water delivery rate to brine tank (gallons per minute)

BT=temperature of the brine.

Based on the results of Table 2, it can be seen that an additional quantity of water in the brine tank is required to dissolve equivalent amounts of potassium chloride depending upon the brine temperature, for example about 11% more at 60° F. (0.219÷2.00) and about 16% more at 52° F. (0.3133÷2.00) and about 24% more at 40° F. (0.4722÷2.00). This increased water allows an amount of potassium chloride to be present in the brine which is substantially equivalent to the amount of sodium chloride which would be present in an amount of brine without the additional water.

Also note from Table 2 that the final brine temperature is approximately 20 degrees lower than the temperature at the start of the fill, i.e., the temperature started at 60° F. and ended at 40° F. Thus, the temperature selected for determining the water adjustment rate and the water adjustment factor should be about 20° less than the temperature of the water admitted to the brine tank. If the temperature of the source water is used to determine the water adjustment rate and multiplier, the relationship discussed above would be adjusted for that 20° difference by substituting (source water temperature−20) for brine temperature which results in the relationships:

$$\begin{matrix}WARFT = ( 6.91 - ( .029 [ SWT - 20 ] ) {10}^{- 3} \\ = ( 7.49 - .029 SWT ) {10}^{- 3}\end{matrix}$$

$$where SWT = source water temperature , and$$

$$Water Adjustment Multiplier$$

$$\begin{matrix}= 1 + WARFT \times dT \\ = 1 + ( 6.91 - [ .029 ( SWT - 20 ) ] ) {10}^{- 3} ( dT ) \\ = 1 + ( 7.49 - .029 ( SWT ) ) {10}^{- 3} ( 100 - SWT ) \\ = 1 + [ .749 + 2.9 {( SWT )}^{2} {10}^{- 5} - .01039 SWT ]\end{matrix}$$

The KCl Water Volume Equivalency (WVE) is based on the KCl Solubility presented in Table 1. The KCl Water Volume Equivalency at a given brine temperature is the gallons of water to obtain the amount of KCl in solution which is equal to an amount of NaCl in solution. It can be determined from Table 1 by dividing the NaCl Solubility (2.99 pounds per gallon of water) by the KCl solubility (see second column of Table 1 for soluability at different temperatures). Thus at 40° the KCl Water Volume Equivalency is 2.99÷2.43=1.230 gallons of water for KCl to have the same amount of KCl in solution as one gallon of NaCl solution. Accordingly, the KCl Water Volume Equivalency at various temperatures is as follows:

| | KCl Water Volume |
|---|---|
| Temp (° F.) | Equivalency |
| 34 | 1.272 |
| 40 | 1.230 |
| 50 | 1.163 |
| 60 | 1.103 |
| 70 | 1.049 |
| 80 | 1.000 |

which are stated above as the Water Adjustment Multipliers.

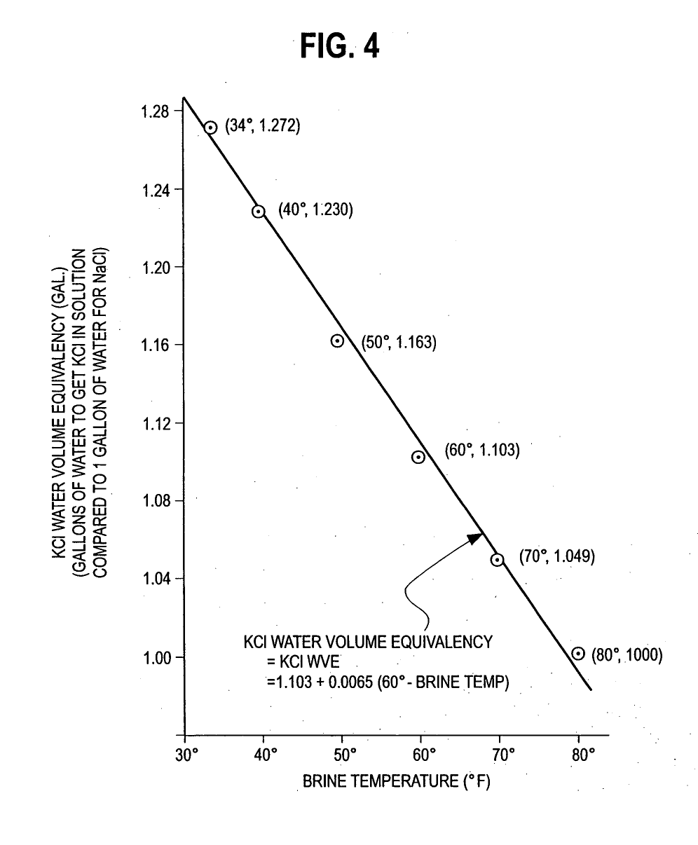

The KCl Water Equivalency values can be used to determine the KCl water volume desired, based on the temperature of the brine. To do so, KCl Water Equivalency is plotted against Brine Temperature, as shown in FIG. 4. The KCl Equivalency can be determined at each temperature from the relationship between the KCl Equivalency and Brine Temperature, which relationship is determined from the slope of the plot of the points; which relationship is KCl Water Volume Equivalency=1.103+0.0065 (60°−Brine Temperature) in the temperature range from 60° to 34°. That relationship also closely approximates the KCl Water Volume Equivalency in other selected temperature ranges. These relationships can also be stated as formulas with other numerical factors for different temperature ranges and “curves” believed to be the best “fit” to the plotted values.

Further, the Water Adjustment Rate (WAR) for KCl, as set forth above, is determined from the data in Table 1 and Table 2. The WAR is based on the additional water needed to put equal amounts of KCl in solution, i.e., equal to the amount of NaCl which is desired if NaCl were to be used. The WAR is the percent increase in water per change of temperature of the brine solution from the standard temperature of 80° F.; 80° F. was selected because the solubility of KCl is substantially the same as the solubility of NaCl at that temperature, i.e., 2.99 lbs. per gallon (see Table 1), and then varies from the solubility of NaCl when the brine temperature is cooler than 80° F. as shown in Table 1. Using 40° F. as an example the WAR for KCl can be determined by calculating the extra water required to put an equivalent amount of KCl in solution at 40°, which is the KCl Water Volume Equivalency of 1.230 gallons minus the amount of water for NaCl which is 1.000 gallon. The result is 0.230 gallons extra water required at 40°. The difference in temperature from the standard is 40° (i.e., 80°−40°). Thus the WAR for brine temperature at 40° is 0.230 gallons÷40°=0.00575 gallons/degree difference from 80° and its units are increased percent volume of water per degree of temperature. WARs for selected other temperatures, determined in the same manner as above, are as follows:

| | Water Adjustment |
|---|---|
| Brine Temp (° F.) | Rate |
| 34 | 0.00592 |
| 40 | 0.00575 |
| 50 | 0.00546 |
| 60 | 0.00517 |
| 70 | 0.00488 |
| 80 | -0- |

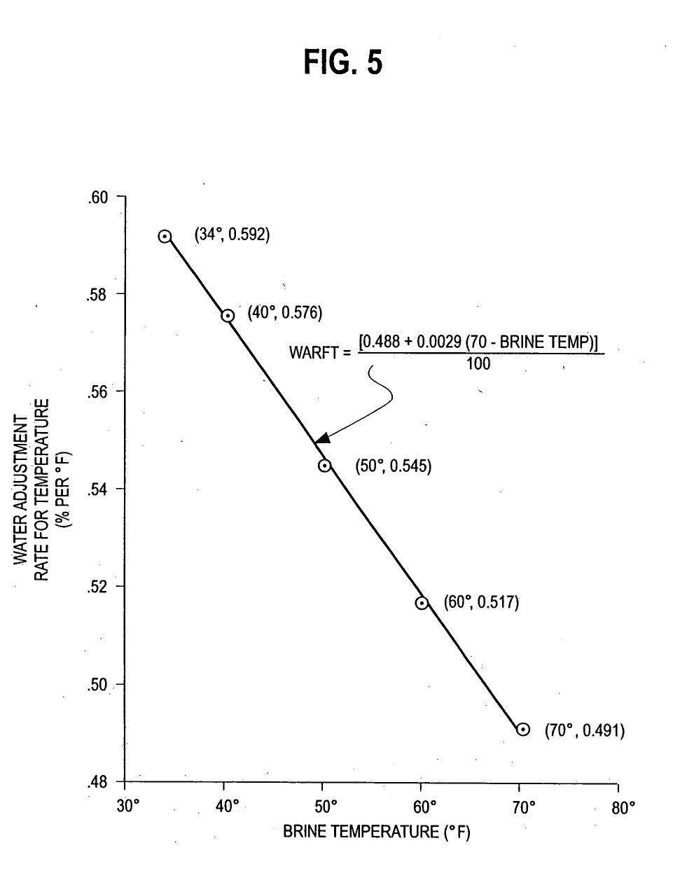

These values can be plotted as shown in FIG. 5. And the relationship between the WAR for KCl and Brine Temperature can be determined from the plot, by well known algebra analysis, to be WAR for KCl=[0.488+0.0029 (70−Brine Temperature)]÷100, for brine temperatures in the range of 60° to 34°. Thus, the relationship set forth above (i.e., the rate of water adjustment for temperature differences for potassium chloride is substantially linear in the range of temperatures ordinarily expected for the brine, and has been found to be directly related to the water temperature as follows: the rate equals [0.488+0.0029 (70−brine temperature)]÷100, which equals (6.91−0.029 brine temperature)10⁻³) is derived from Table 1.

The preferred method of using KCl as the regenerant is described as follows. At regular time intervals during the fill, the temperature at temperature sensor 56 is measured. From this temperature, the solubility of the salt is calculated, and from this value the required volume of fill water and ultimately the required fill time may be calculated, as shown in Table 2. The fill then proceeds until the required fill time is approximately equal to the actual fill time.

Even after the fill ends, the brine temperature is often observed to continue to drop when KCl is used. This may be due to the dissolution rate of KCl which is less than that of NaCl. In other words, the KCl continues to dissolve even after the flow of water stops, thereby cooling the brine even further. The temperature drop is observed to be fairly small—typically 2° F. The temperature drop reduces the solubility of KCl even further, so that less dissolved KCl is present in the brine as result. The way to compensate for this effect is to add more water during the fill step by increasing the fill time. Typically, a 1% increase in the fill time is all that is required.

When the fill time is adjusted, the brine draw time must also be adjusted to ensure that the required amount of brine is withdrawn from brine tank 34. Typically, the ratio of the brine draw time to the fill time is a fixed quantity, so that the brine draw time may be taken to be the fill time multiplied by this quantity. The slow rinse time is typically fixed. Preferably, controller 48 calculates the necessary brine draw time based on the fill time actually used. The total “brine time” is then the sum of this necessary brine time and the slow rinse time. Controller 48 maintains control valve 24 in the brine draw/slow rinse configuration for this “brine time” to ensure that the required amount of brine is withdrawn. In the case where the fill time for KCl is increased by 25% relative to NaCl, a corresponding increase in the “brine time” for KCl of approximately 12.5% relative to NaCl is found to be sufficient.

The above described embodiments are merely illustrative of the features and advantages of the present invention. Other arrangements and advantages may be devised by those skilled in the art without departing from the spirit and scope of the present invention. Accordingly, the invention should not be deemed to be limited to the above detailed description but only by the claims that follow.

We claim:

1. A method for operating a water softener having a resin bed and a brine tank, said water softener being connected to a source of water, to provide a first mode of operation wherein a first salt type is used for regeneration and a second mode of operation wherein a second salt type is used for regeneration, the method comprising the steps of:
a. selecting a salt type;
b. adding a quantity of salt to the brine tank; the salt being of the selected salt type;
c. adding a first quantity of water to the brine tank if said selected salt type is the first salt type, said first quantity of water being determined by the solubility of said selected salt type, whereby the water forms a brine of a desired concentration;
d. adding a second quantity of water to the brine tank if said selected salt type is the second salt type, said second quantity of water being in addition to the first quantity of water and being determined by the solubility of said second salt type, said second quantity of water forming a brine of the desired concentration; and
e. exposing the resin bed to said brine to regenerate the resin bed.

2. The method of claim 1, wherein the desired concentration is a saturated brine with a predetermined quantity of the selected salt in solution.

3. The method of claim 1, wherein said first salt type is sodium chloride and said second salt type is potassium chloride.

4. The method of claim 1, wherein said second quantity of water is about twenty-five percent of said first quantity of water.

5. The method of claim 1, further comprising the steps of:
a. determining the temperature of the brine; and
b. calculating said second quantity of water based on said temperature.

6. The method of claim 5, wherein said second salt type is potassium chloride.

7. The method of claim 1, further comprising the steps of:
a. measuring the water temperature of the source water; and
b. calculating said second quantity of water based on said water temperature.

8. The method of claim 7, wherein said second salt type is potassium chloride.

9. The method of claim 1, further comprising the steps of:
a. measuring the temperature of said brine; and
b. calculating said second quantity of water based on said temperature.

10. The method of claim 9, wherein said second salt type is potassium chloride.

11. A method for regenerating a water softener, having a resin bed and a brine tank, comprising the steps of:
a. commencing a flow of water into the brine tank, said brine tank containing a quantity of a regenerant salt, whereby regenerant salt dissolves to form a brine;
b. measuring the temperature of said brine;
c. calculating a theoretical water quantity necessary to dissolve a predetermined quantity of the regenerant salt based on said temperature;
d. maintaining and measuring said flow of water until the measured quantity of water in the brine tank equals the theoretical water quantity; and
e. exposing the resin bed to said brine to regenerate the resin bed.

12. The method of claim 11, further comprising the steps of:
a. measuring the temperature of said brine at regular intervals of time;
b. re-calculating a theoretical water quantity based on the most recently measured brine temperature and the regenerant salt selected; and
c. maintaining said flow of water so that the measured quantity of water is at least as great as the most recently re-calculated theoretical quantity of water.

13. A water softener connected to a source of water, comprising:
a. a brine tank;
b. a resin tank;
c. a resin bed disposed in said resin tank;
d. a piping system connecting said brine tank to said resin tank;
e. salt selection means for selecting a salt type from a plurality of salt types;
f. water quantity means for calculating and measuring a quantity of water based on said selected salt type; and
g. means for connecting said brine tank to the source of water,
h. whereby said brine tank is filled with said quantity of water to form a brine, and said brine may be transferred through said piping system to said resin tank to regenerate said resin bed.

14. The water softener claimed in claim 13 including
a. a temperature sensor disposed in said brine tank for measuring the temperature of the brine therein;
b. said water quantity means includes means for calculating a theoretical fill time based on said temperature; and
c. means for filling said brine tank with water for an amount of time at least as great as said theoretical fill time.

15. A water softener, comprising:
a. a resin tank;
b. a resin bed disposed in said resin tank;
c. a brine tank for preparing a salt solution for regenerating the resin bed;
d. a piping system connecting said brine tank to said resin tank;
e. salt selection means for selecting a regenerative salt type from a plurality of salt types;
f. water dispensing means for measuring and placing either a first quantity of water in the brine tank when a first salt type is selected or a second quantity of water in the brine tank when a second salt type is selected, said second quantity of water being greater than the first quantity of water; said water interacting with a salt in the brine tank to form a brine;
g. means for connecting said brine tank to a source of water;
h. brine draw means for withdrawing brine from the brine tank and running the brine to the resin tank and through the resin bed, whereby the resin bed is washed with a first quantity of brine having a volume substantially equal to the first quantity of water if the first salt type is selected and a second quantity of brine having a volume substantially equal to the second quantity of water if the second salt type is selected.

16. In a water softener having a resin tank, a resin bed disposed in the resin tank, a brine tank intended to contain a salt for regenerating the resin bed, the improvement comprising: a brine feed-water selection means for selecting either a predetermined first quantity of water or a variable second quantity of water, either of said quantities to be added to the brine tank during regeneration, the first water quantity being associated with a first salt type, the second water quantity being associated with a second salt type, the second water quantity being greater than the first water quantity.

17. The water softener of claim 16 wherein the second water quantity is between 10.2% and 27.2% greater than the first water quantity.

18. The water softener of claim 16 wherein the second water quantity is about 25% greater than the first water quantity.

19. The water softener of claim 15 and including a temperature sensing means for determining the temperature of the brine, and wherein the water dispensing means adjusts the quantity of water for the second water quantity whereby it is substantially equal to 2 Q=1 Q+1 QRT, wherein 2 Q equals the second water quantity and 1 Q equals the first water quantity and R equals an adjustment rate per degree Fahrenheit of the brine below 80 degrees Fahrenheit and T equals the temperature of the brine in degrees Fahrenheit, and the adjustment rate is in the range of 0.0054 to 0.0058.

20. In a water softener having a resin tank, a resin bed disposed in the resin tank, and a brine tank for preparing a brine for regenerating the resin bed, the improvement comprising:
a. a brine feed-water means for filling the brine tank with water to prepare a brine;
b. a temperature sensing means for determining the temperature of the brine; and
c. adjustment means coupled with the feed-water means and the temperature sensing means for changing the quantity of water fed into the brine tank in accordance with the temperature sensed by the temperature sensing means.

21. The water softener of claim 20 wherein the adjustment means adjusts the water quantity at a rate substantially equal to −0.0029 times the temperature sensed.

22. The water softener of claim 20 wherein the brine feed-water adjustment means adjusts the water quantity substantially in accordance with −0.0077 times the temperature sensed.

23. The water softener of claim 20 including a salt selection means, the salt selection means being coupled with the adjustment means, wherein the adjustment means adjusts the water quantity at a rate per degree change in the temperature sensed, said rate being substantially in accordance with (the solubility quotient −1) divided by 40, wherein the solubility quotient equals the solubility at 80° F. of the salt selected divided by the solubility at 40° F. of the salt selected.

24. A method for regenerating a water softener having a resin bed and a brine tank, said water softener being connected to a source of water, the method comprising the steps of:
a. selecting a salt type from the group consisting of sodium chloride and potassium chloride;
b. adding to the brine tank a quantity of salt of said selected salt type;
c. adding to the brine tank a first quantity of water to form a brine, said first quantity of water being determined by the amount of salt desired for regeneration at a standard solubility;
d. determining the solubility of the salt in the brine;
e. adding to the brine tank an additional quantity of water if the solubility of the brine is determined to be different than the standard solubility; and
f. exposing the resin bed to said brine to regenerate the resin bed.

25. The method of claim 24, wherein said standard solubility is about 2.99 pounds per gallon and said additional quantity of water is at least 16 percent of the first quantity of water.

26. The method of claim 25, wherein said additional quantity of water is about twenty-five percent of said first quantity of water.

27. The method of claim 24, wherein said standard solubility is about 2.99 pounds per gallon and further comprising the steps of:
a. selecting a temperature parameter; and
b. calculating said additional water quantity as being substantially equal to (6.91−[0.029 brine temperature])10⁻¹ (80−brine temperature) as a percent.

28. The method of claim 24, further comprising the steps of:
a. measuring the temperature of the source water; and
b. calculating said additional water quantity as being substantially equal to (74.9+0.0029 times the water source temperature raised to the second power−1.309 times the water source temperature) as a percent.

29. The method of claim 24, further comprising the steps of:
a. determining the temperature of said brine; and
b. calculating said additional water quantity as being a function of (the amount of salt desired in the brine+solubility of the salt at 80° F.) ([solubility of the salt at 80° F.÷solubility of the salt at said temperature determined]−1).

30. The method of claim 24, wherein the regenerant salt is potassium chloride and further comprising the steps of:
a. measuring the temperature of the brine; and
b. calculating said additional water quantity as being substantially equal to (6.91−[0.029 brine temperature])10⁻¹(80−brine temperature) as a percent.

31. A method for regenerating a water softener with a salt having a solubility which varies in accordance with the temperature of the brine, the water softener having a resin bed and a brine tank and being connected to a source of water, the method comprising the steps of
a. adding the salt to the brine tank;
b. determining the quantity of salt desired for regeneration;
c. adding a first quantity of water to the brine tank to form a brine, said first quantity of water being approximately equal to a theoretical amount as if the brine were at room temperature, said theoretical amount being said quantity of salt desired for regeneration divided by the solubility of the salt at room temperature;
d. determining the temperature of the brine;
e. determining the solubility of the brine at the temperature determined;
f. adding an additional quantity of water to the brine tank, said additional quantity being determined as a function of the solubility of the salt at the temperature determined; and
g. exposing the resin bed to said brine to regenerate the resin bed.

32. The method of claim 31 wherein the function is substantially equal to the solubility difference divided by the solubility product, the solubility difference being determined by subtracting the solubility at the determined temperature from the solubility at room temperature, the solubility product being determined by multiplying the two solubilities.

33. The method of claim 31 wherein said additional quantity is substantially equal to (the amount of salt desired for regeneration÷the solubility of the salt at the temperature determined) minus (the amount of salt desired for regeneration÷solubility of the salt at room temperature).
